(19) United States
(12) Patent Application Publication
(10) Pub. No.: US 2022/0215570 A1
(43) Pub. Date: Jul. 7, 2022

(54) PROGRESS DETERMINATION SYSTEM, PROGRESS DETERMINATION METHOD, AND STORAGE MEDIUM

(71) Applicant: KABUSHIKI KAISHA TOSHIBA, Tokyo (JP)

(72) Inventors: Yusuke AOKI, Yokohama (JP); Yuki SAKURAI, Yokohama (JP); Tomoyuki SHIBATA, Kawasaki (JP)

(73) Assignee: KABUSHIKI KAISHA TOSHIBA, Tokyo (JP)

(21) Appl. No.: 17/464,849

(22) Filed: Sep. 2, 2021

(30) Foreign Application Priority Data
Jan. 4, 2021 (JP) 2021-000118

(51) Int. Cl. G06T 7/62; G06T 7/90; G06T 7/11; G06T 7/13; G06K 9/00

(52) U.S. Cl. CPC G06T 7/62; G06T 7/90; G06T 7/11; G06K 2209/21; G06K 9/00369; G06T 2207/10024; G06T 7/13

(57) ABSTRACT

According to one embodiment, a progress determination system includes a first acquisition part and a second acquisition part. The first acquisition part acquires area data relating to area values of a plurality of colors from an image of an article, the article relating to a task. The second acquisition part acquires a classification result from a classifier by inputting the area data to the classifier. The classification result indicates a progress amount.

### CROSS-REFERENCE TO RELATED APPLICATIONS

This application is based upon and claims the benefit of priority from Japanese Patent Application No. 2021-000118, filed on Jan. 4, 2021; the entire contents of which are incorporated herein by reference.

### FIELD

Embodiments described herein relate generally to a progress determination system, a progress determination method, and a storage medium.

### BACKGROUND

Various technologies are being developed to automatically determine the progress of a task. It is desirable to increase the accuracy of determining the progress.

### BRIEF DESCRIPTION OF THE DRAWINGS

FIG. 1 is a schematic view illustrating a progress determination system according to an embodiment;

FIGS. 2A and 2B are schematic views for describing the processing of the progress determination system according to the embodiment;

FIGS. 3A to 3D are schematic views for describing the processing of the progress determination system according to the embodiment;

FIGS. 4A to 4D are schematic views for describing the processing of the progress determination system according to the embodiment;

FIGS. 5A and 5B are schematic views for describing the processing of the progress determination system according to the embodiment;

FIG. 6 is a schematic view illustrating an output example of the progress determination system according to the embodiment;

FIGS. 7A and 7B are schematic views illustrating another output example of the progress determination system according to the embodiment;

FIG. 8 is a schematic view for describing the method for calculating the man-hours;

FIG. 9 is a flowchart illustrating processing when training the classifier according to the embodiment;

FIG. 10 is a flowchart illustrating processing of the progress determination system according to the embodiment;

FIG. 11 is a flowchart illustrating the processing when training the classifier in the first modification of the embodiment;

FIG. 12 is a flowchart illustrating processing of the progress determination system according to the first modification of the embodiment;

FIG. 13 is a schematic view illustrating a progress determination system according to a second modification of the embodiment;

FIG. 14 is a schematic view illustrating a work site to which the progress determination system according to the second modification of the embodiment is applied;

FIGS. 15A to 15C are graphs illustrating examples of area data;

FIG. 16 is a flowchart illustrating the processing of the progress determination system according to the second modification of the embodiment; and

FIG. 17 is a schematic view illustrating a hardware configuration.

### DETAILED DESCRIPTION

According to one embodiment, a progress determination system includes a first acquisition part and a second acquisition part. The first acquisition part acquires area data from an image of an article. The area data relates to area values of a plurality of colors. The article relates to a task. The second acquisition part acquires a classification result from a classifier by inputting the area data to the classifier. The classification result indicates a progress amount.

Various embodiments are described below with reference to the accompanying drawings. In the specification and drawings, components similar to those described previously or illustrated in an antecedent drawing are marked with like reference numerals, and a detailed description is omitted as appropriate.

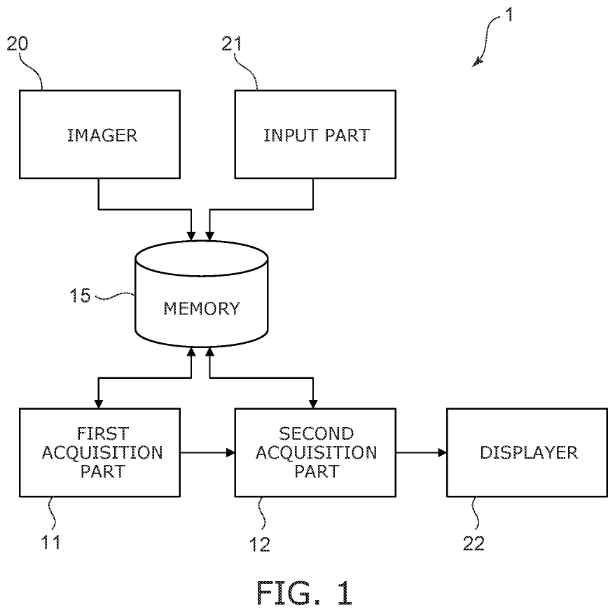

FIG. 1 is a schematic view illustrating a progress determination system according to an embodiment.

The progress determination system according to the embodiment is used to determine the progress amount of a task from an image of an article relating to the task. The task is a prescribed job such as manufacturing, logistics, construction, inspection, etc. The article is a product or a device that is the object of the task, a device, component, or tool that is used in the task, etc.

As illustrated in FIG. 1, the progress determination system 1 includes a first acquisition part 11, a second acquisition part 12, memory 15, an imager 20, an input part 21, and a displayer 22. The imager 20 generates an image by imaging the article relating to the task. The imager 20 repeatedly images the article. The imager 20 may generate a video image by imaging. The imager 20 stores the image or the video image in the memory 15.

Article identification data of the imaged article, task identification data of the task to which the article is related, and the imaging time are associated with the image. The article identification data and the task identification data are preset by a user before starting the imaging. The user is a worker, a supervisor of the task, a manager that manages the progress determination system 1, etc.

The first acquisition part 11 acquires an image stored in the memory 15. When a video image is stored in the memory 15, the first acquisition part 11 cuts out a still image from the video image. The first acquisition part 11 calculates surface area values (area values) of multiple colors of the image. Specifically, the colors that are extracted from the image are preset by the user and stored in the memory 15. The user presets the ranges of the pixel values corresponding to the colors.

For example, when the pixel values of the pixels in the image are based on RGB color space, the pixel values include the luminances of R, G, and B. An upper limit and a lower limit of the luminance are set as a range for each of R, G, and B. When the pixel values of the pixels in the image are based on Lab color space, an upper limit and a lower limit are set as a range for the values of each of L, a, and b. The range is set for each of the colors. For example, when four colors are used to determine the progress amount, a range is set for each of the four colors.

The first acquisition part 11 compares the pixel values of the pixels to multiple ranges. When the pixel value is included in one of the ranges, the first acquisition part 11 determines that the color of the pixel having that pixel value is the color that corresponds to the range. By comparing the pixel values and the multiple ranges, it is determined whether or not the colors of the pixels are one of the preset colors. The first acquisition part 11 calculates the number of pixels of each color based on the comparison result. The first acquisition part 11 uses the number of pixels of each color as the area value of each color. The area data relating to the area values of the colors is transmitted to the second acquisition part 12 by the first acquisition part 11. For example, the area data includes the area value of each color. The area data may include a ratio among the area values or distribution of the area values. The first acquisition part 11 associates the area data with the article identification data, the task identification data, and the imaging time and stores the result in the memory 15.

When the second acquisition part 12 acquires the area data including one or more selected from the area values, the ratio, and the distribution, the second acquisition part 12 inputs the area data to the classifier. When the area data is input to the classifier, the classifier outputs a classification result indicating the progress amount of the task. The classifier is pre-trained by the user and is stored in the memory 15. For example, a classifier trained using a random forest, a Bayes classifier, or the like is used as the classifier.

Alternatively, a histogram showing the area value, the ratio, or the distribution may be used as the area data. In other words, the area data may be image data showing information regarding to the area value of each color. In this case, a neural network for classifying the image data is used as the classifier. Preferably, the neural network includes a Convolutional Neural Network (CNN).

When the area data is input to the classifier, the classifier outputs the classification result of the progress amount. For example, the classifier outputs a match ratio for each progress amount of the area data. The second acquisition part 12 selects the progress amount that has the highest match ratio from the classification result. The selected progress amount is acquired by the second acquisition part 12 as the progress amount that corresponds to the area data that is input. The second acquisition part 12 stores the acquired progress amount in the memory 15 as the progress amount of the task at the imaging time associated with the area data.

The user uses the input part 21 when inputting the various data described above to the progress determination system 1. The displayer 22 displays the data output from the second acquisition part 12 so that the data can be visually checked by the user.

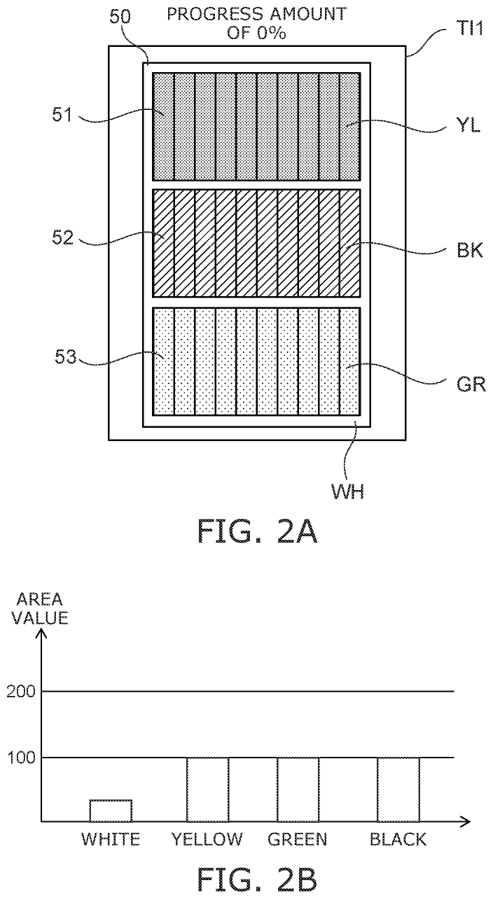

FIGS. 2A to 5B are schematic views for describing the processing of the progress determination system according to the embodiment.

The processing of the progress determination system 1 will now be described with reference to specific examples. Hereinbelow, an example in which the area value of each color in the image is used as the area data will be described.

### Training

The user pre-trains the classifier. The user prepares teaching data. For example, the teaching data includes multiple training images and multiple progress amounts that are respectively associated with the multiple training images. For example, the user generates the training images by using the imager 20 to image the article in states that correspond to the progress amounts. The imaging conditions of the training image are set to be similar to the imaging conditions when determining the progress amount. For example, the position and the angle of the imager 20 with respect to the article are set to be the same between when preparing the training image and when determining the progress amount. A CAD drawing, a 3D model image, an illustration drawn by a human, etc., may be used as the training image instead of an image.

In the example, the first acquisition part 11 functions as a trainer that trains the classifier. The first acquisition part 11 acquires area data from the training images. The first acquisition part 11 trains the classifier by using the area data as input data and by using the progress amount associated with the training image as a label.

FIG. 2A is an example of a training image prepared by the user. A shelf 50 is visible in a training image TI1. Components 51 to 53 that are used in a task are stored on the shelf 50. The color of the shelf 50 is white (WH). The color of the component 51 is yellow (YL). The color of the component 52 is black (BK). The color of the component 53 is green (GR). The progress amount “0%” is associated with the training image TI1. The progress amount may be expressed as a percent as in the example or may be expressed as another numerical value.

In such a case, the four colors of white, yellow, green, and black can be used to determine the progress amount. The user sets the range of the luminance for each of white, yellow, green, and black. For example, when the pixel values are based on the RGB color space and are represented by 256 gradations, the range of (R:G:B)=(245 to 255:245 to 255:245 to 255) is set as the white range. The range of (R:G:B)=(245 to 255:245 to 255:0 to 10) is set as the yellow range. The range of (R:G:B)=(0 to 10:245 to 255:0 to 10) is set as the green range. The range of (R:G:B)=(0 to 10:0 to 10:0 to 10) is set as the black range.

The first acquisition part 11 compares the pixel values of the pixels of the training image TI1 of FIG. 2A with the ranges of the colors set by the user. FIG. 2B is an example of the area data of the training image TI1 of FIG. 2A obtained from the comparison result. The first acquisition part 11 performs supervised learning of the classifier by using the area data of FIG. 2B as the input data and by using 0% as the label.

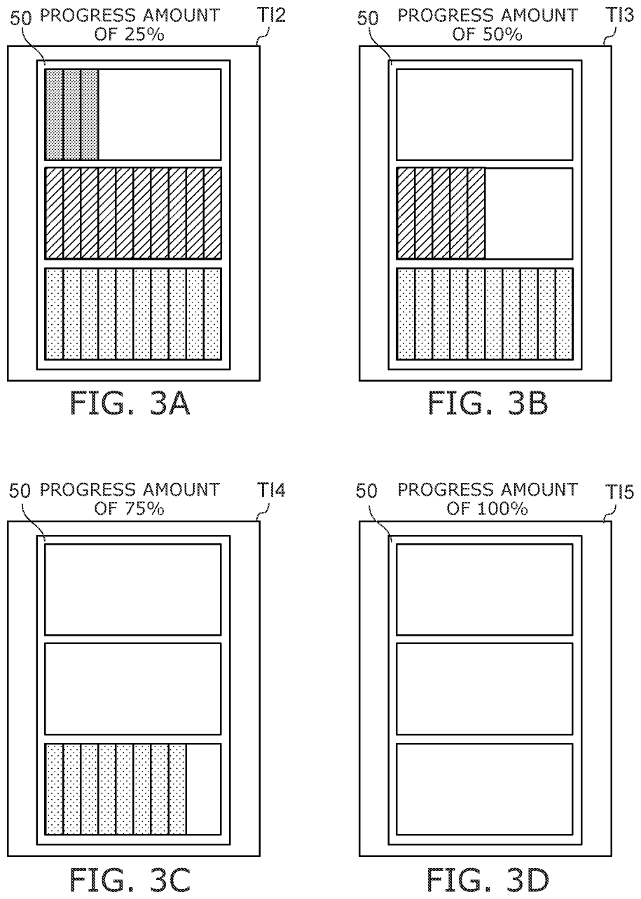

FIGS. 3A to 3D illustrate other training images TI2 to TI5 and the progress amounts associated with the training images of the training images TI2 to TI5. In the task of the example, the component 51 is taken out first. Then, the component 52 is taken out. Finally, the component 53 is taken out. The area of the color of the component decreases as the component is taken out. The area of the color of the shelf 50 increases. Similarly to the training image TI1, the first acquisition part 11 acquires the area data from the training images TI2 to TI5. The first acquisition part 11 sequentially trains the classifier by using the multiple sets of area data and the multiple labels (the progress amounts). Thereby, the classifier is trained to be able to output the progress amount according to the input of the area data.

Instead of the progress amount, the classifier may output the classification result of a process included in the task. For example, when one task includes multiple processes, the process corresponds to the progress amount. In such a case, the training image and the name of the process corresponding to the training image are prepared as the teaching data. The first acquisition part 11 trains the classifier by using the area data as the input data and by using the process name as the label. When acquiring the process name, i.e., the classification result, the second acquisition part 12 acquires the progress amount associated with the process name as the progress amount corresponding to the area data that is input.

Or, unsupervised learning of the classifier may be performed. The first acquisition part 11 acquires multiple sets of area data from multiple training images that are prepared. The first acquisition part 11 performs unsupervised learning by sequentially inputting the multiple sets of area data to the classifier. Thereby, the classifier is trained to be able to classify the multiple sets of area data. The first acquisition part 11 stores the trained classifier in the memory 15.

When unsupervised learning is performed, and when the area data is input to the classifier, the classifier outputs the classification result of the area data. The second acquisition part 12 refers to the training image belonging to the classification that is output and acquires the progress amount associated with the training image as the progress amount corresponding to the area data that is input to the classifier.

As described above, due to the supervised learning, the classifier may output a classification result that directly indicates the progress amount. Due to the unsupervised learning, the classifier may output a classification result that indirectly indicates the progress amount. In any case, the second acquisition part 12 can obtain the progress amount of the task when imaged based on the classification result that indicates the progress amount.

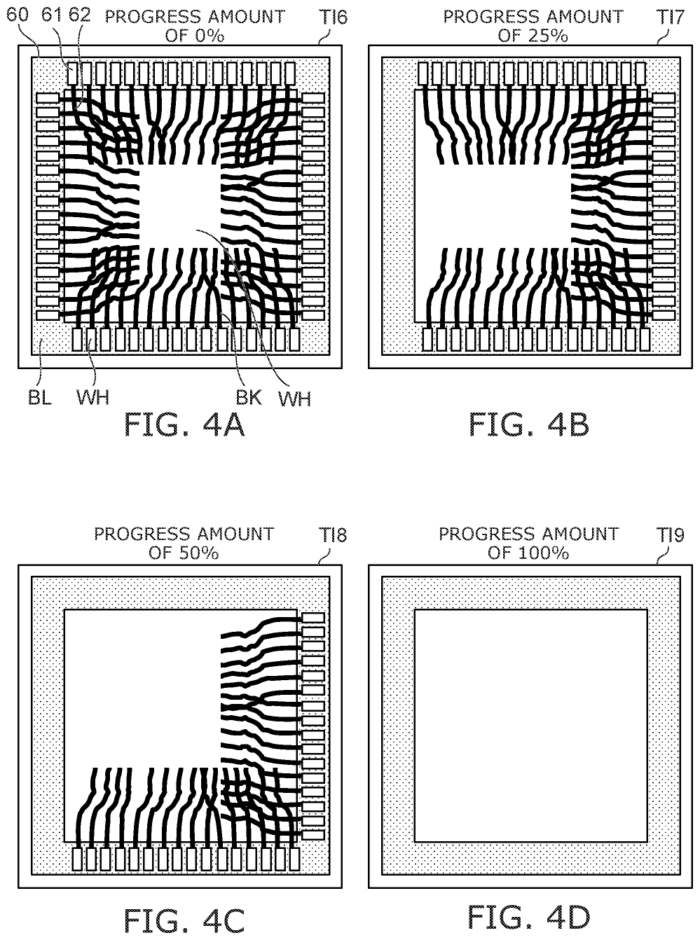

FIGS. 4A to 4D are examples of other training images. A parts box 60 is visible in training images TI6 to TI9. Cables 62 to which tags 61 are attached are stored in the parts box 60. The color of the upper surface of the parts box 60 is blue (BL). The color of the tag 61 and the inner side of the parts box 60 is white (WH). The color of the cable 62 is black (BK). The progress amounts “0%”, “25%”, “50%”, and “100%” are respectively associated with the training images TI6 to TI9.

The first acquisition part 11 calculates area data that includes the area values of the colors of blue, white, and black from the training images TI6 to TI9. The first acquisition part 11 sequentially trains the classifier by using the multiple sets of area data and the multiple progress amounts.

### Determination

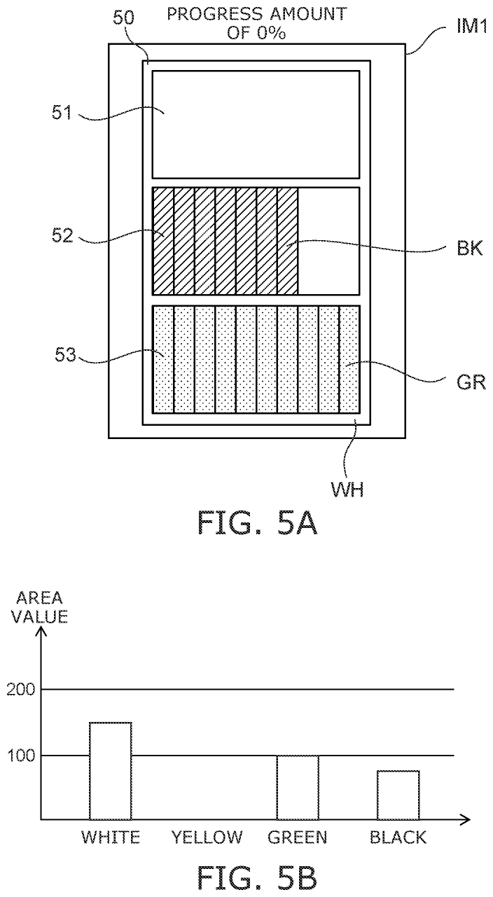

FIG. 5A is an example of an image IM1 that is imaged by the imager 20 to determine the progress amount. In the state of the image IM1, all of the components 51 are taken out; and a portion of the components 52 is taken out. The first acquisition part 11 calculates the area values of the colors from the image IM1. FIG. 5B illustrates the area values of the colors calculated from the image IM1 of FIG. 5A.

The second acquisition part 12 inputs the area data of FIG. 5B to the classifier. For example, the classifier outputs the classification result that the progress amount corresponding to the input area data is 50%. The second acquisition part 12 acquires the progress amount “50%” as the progress amount of the task when the image IM1 is imaged. Or, the classifier outputs a classification result that the area data that is input belongs to the same classification as the area data of the training image TI3 of FIG. 3B. The second acquisition part 12 acquires the progress amount “50%” associated with the training image TI3 as the progress amount of the task when the image IM1 is imaged.

The second acquisition part 12 may further calculate actual man-hours. For example, the time that the imaging by the imager 20 is started to the time that the image is obtained is calculated as the actual man-hours by the second acquisition part 12. The second acquisition part 12 associates the actual man-hours and the progress amount and stores the result in the memory 15.

### Preprocessing

The first acquisition part 11 may cut out a portion from the image generated by the imager 20. The user pre-designates the region of the image in which the article is visible. For example, the coordinates of four corners are designated; and a rectangular image in which the article is visible is cut out. The cutting out is performed for both the training image and the image for progress determination. By cutting out the image, the effects on the training and the determination of the colors of equipment, the floor, the walls, humans, etc., at the periphery of the article can be suppressed.

The first acquisition part 11 may remove the region in which the human is visible from the cut-out image. For example, an identifier is prepared beforehand for identifying the human in the image. The identifier includes a neural network. Favorably, a convolutional neural network (CNN) is used. Supervised learning is pre-performed so that the identifier can identify the human from the image. The first acquisition part 11 removes the identified region when a human is identified in the image by the identifier. The effects on the determination of the color of the clothes of the human, the color of an article carried by the human, etc., can be suppressed thereby.

The first acquisition part 11 may normalize at least one of the brightness or the contrast of the image. For example, the first acquisition part 11 normalizes the luminance and the luminance contrast. The normalization is performed for both the training image and the image for progress determination. By the normalization, the effects on the pixel values of the change of the brightness of the work site, the change of the sets of the camera, etc., can be reduced.

### Display

The displayer 22 displays the data output from the second acquisition part 12. For example, the second acquisition part 12 outputs the progress amount and the task performance to the displayer 22. The task plan may be stored in the memory 15. The second acquisition part 12 further acquires the task plan and outputs the progress amount, the task performance, and the task plan to the displayer 22.

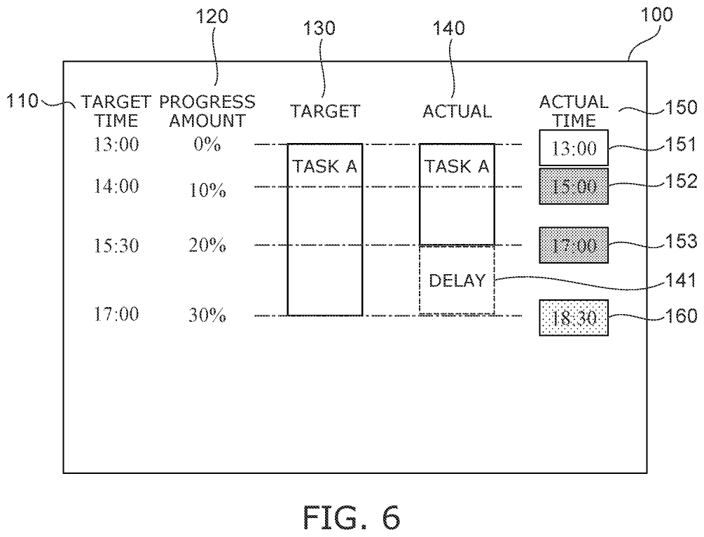

FIG. 6 is a schematic view illustrating an output example of the progress determination system according to the embodiment.

The second acquisition part 12 causes the displayer 22 to display a determination result screen 100 illustrated in FIG. 6. A target time 110, a progress amount 120, target man-hours 130, actual man-hours 140, and an actual time 150 are displayed in the determination result screen 100.

The task plan includes the target time 110 and the target man-hours 130. The target time 110 is the target time at which each of the progress amounts 120 is completed. The target man-hours 130 is the target man-hours for the task. In the example, the target man-hours 130 is represented by comparing the target time 110 and the length of the bar. Specifically, the bar extends from the target time of 13:00 to 17:00; and the target man-hours is 4 hours.

The task performance includes the actual man-hours 140 and the actual time 150. The actual time 150 is the time at which each of the progress amounts 120 is actually completed. The actual time 150 is the actual man-hours necessary until each of the progress amounts is completed. In the example, the actual man-hours 140 is represented by comparing the actual time 150 and the length of the bar. Specifically, the bar extends from the target time of 13:00 to 17:00; and the actual man-hours is 4 hours.

The actual man-hours 140 and the actual time 150 are determined based on the time at which the image is imaged and the progress amount acquired by the second acquisition part 12. For example, the time at which the imaging by the imager 20 is started is considered to be the start time of the task. The time until the progress amount is completed is calculated as the actual man-hours.

In the example of FIG. 6, the latest determination result of the progress amount is obtained at 17:00. In the task plan, a task A is started at 13:00; and targets are set so that the progress amounts of 10%, 20%, and 30% are completed respectively at 14:00, 15:30, and 17:00. In the actual task, the task A is started at 13:00; and the progress amounts of 10% and 20% are completed respectively at 15:00 and 17:00. The progress amount does not reach 30%. The actual time that the progress amount of 10% is completed and the actual time that the progress amount of 20% is completed are later than the target times.

For example, when the actual time of one progress amount is delayed from the target time, the second acquisition part 12 displays the actual time to be discriminable from the other actual times. In the example of FIG. 6, an actual time 152 of “15:00” and an actual time 153 of “17:00” are displayed to be discriminable from an actual time 151 of “13:00”. Thereby, the user can easily check which progress amounts are later than the target. A difference 145 between the target man-hours 130 and the actual man-hours 140 may be shown in the actual man-hours 140. Thereby, the user intuitively and easily understands the difference between the target man-hours 130 and the actual man-hours 140.

The second acquisition part 12 may predict the completion time of one progress amount. The completion time is calculated using the difference between the target time and the actual time of the latest progress amount. The second acquisition part 12 adds the difference between the target time of the latest progress amount and the target time of the next progress amount to the actual time of the latest progress amount. The completion time of the next progress amount is calculated thereby.

In the example of FIG. 6, the difference between the target time of the progress amount of 20% and the target time of 30% is 1.5 hours. The second acquisition part 12 adds 1.5 hours to the actual time of the progress amount of 20% and calculates 18:30 as a completion time 160.

Or, for the completion time, the speed of the task until the latest progress amount is completed may be considered. The second acquisition part 12 compares the target progress amount and the actual progress amount at the last time at which the progress amount is determined. The second acquisition part 12 calculates the ratio of the actual progress amount to the target progress amount. The second acquisition part 12 multiplies the ratio by the difference between the target time of the latest progress amount and the target time of the progress amount at which the completion time is calculated. The second acquisition part 12 sums the difference multiplied by the ratio to the last actual time at which the progress amount is determined.

For example, in the example of FIG. 6, the second acquisition part 12 compares the target progress amount of 30% and the actual progress amount of 20% at 17:00 at which the last progress amount is determined. The second acquisition part 12 calculates a ratio of the actual progress amount of 20% to the target progress amount of 30%, i.e., 0.67. The second acquisition part 12 multiplies the ratio of 0.67 by the difference of 1.5 hours between the target time 15:30 at the latest progress amount of 20% and the target time 17:00 at the progress amount of 30% at which the completion time is calculated. The second acquisition part 12 adds the product of 1.5 hours and 0.67 to the last actual time 17:00 at which the progress amount is determined. Thereby, 19:15 is calculated as the completion time.

By the method described above, the second acquisition part 12 may predict the completion time of the progress amount of 100%. In other words, the completion time of the progress amount of 100% is the anticipated time of the end of the task.

The convenience of the user can be improved by predicting the completion time based on the determination result of the latest progress amount.

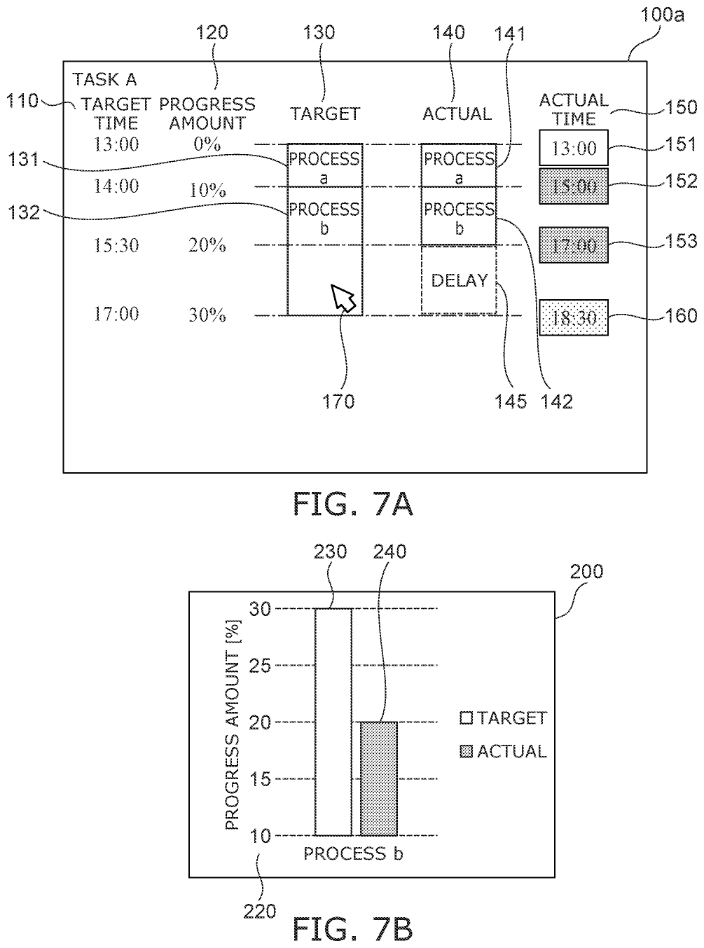

FIGS. 7A and 7B are schematic views illustrating another output example of the progress determination system according to the embodiment.

When one task includes multiple processes, the progress amount and the process may be associated in the task plan. For example, the second acquisition part 12 acquires the process name associated with the progress amount when acquiring the progress amount.

In the example illustrated in FIG. 7A, the task A includes processes a and b. For example, the progress amounts of 0% to 10% of the task A are associated with the process a. The progress amounts of 10% to 30% of the task A are associated with the process b. Target man-hours 131 of the process a and target man-hours 132 of the process b are displayed in the target man-hours 130. Target man-hours 141 of the process a and target man-hours 142 of the process b are displayed in the actual man-hours 140.

A comparison of the target and the performance of the progress amount for each process may be displayed. For example, the user can move a pointer 170 displayed in the displayer 22 by operating the input part 21. When the user aligns the pointer 170 with one of the processes of a target performance 130 and clicks, the details of the process are displayed such as those illustrated in FIG. 7B. In a detail screen 200 illustrated in FIG. 7B, a progress amount 220, a target progress amount 230, and an actual progress amount 240 are displayed. The target progress amount 230 illustrates the progress amount to be completed by the time at which the latest image is imaged. The actual progress amount 240 illustrates the progress amount to be completed by the time at which the latest image is imaged. By the display of the detail screen 200, the user can easily ascertain the details of each of the processes even when the number of processes is high.

The man-hours of the processes may be calculated based on the determination result of the progress amount, the processes associated with the progress amount, and the imaging time. In the example illustrated in FIGS. 7A, 2 hours from 13:00 to 15:00 can be calculated as the actual man-hours of the process a. 2 hours from 15:00 to 17:00 can be calculated as the actual man-hours of the process b.

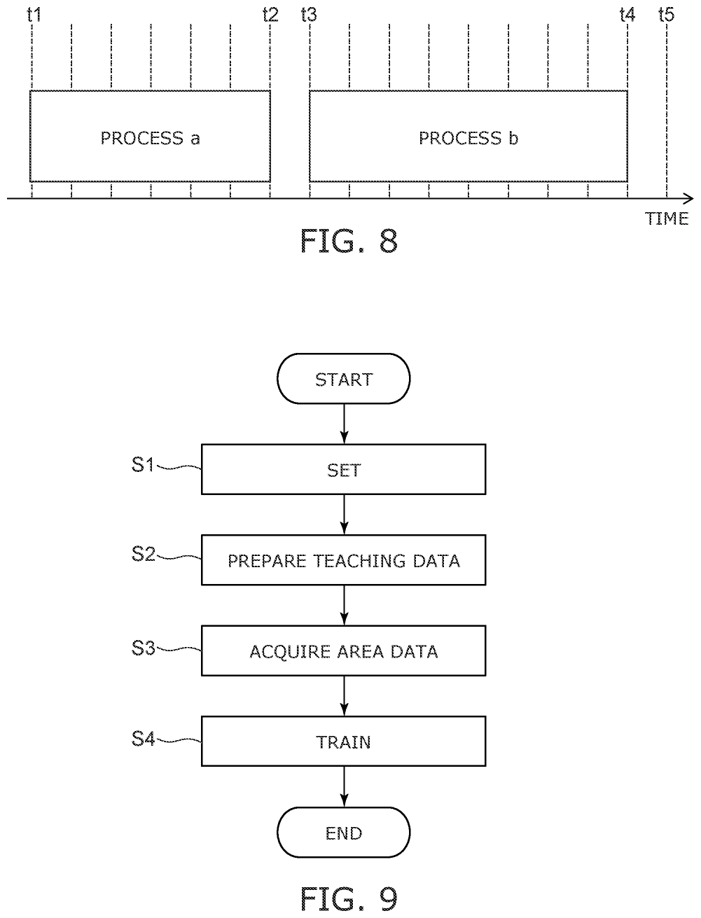

FIG. 8 is a schematic view for describing the method for calculating the man-hours. A more detailed method for calculating the man-hours is described with reference to FIG. 8. One process is associated with one progress amount. In the example of FIG. 7A, the process a is associated with the progress amount that is not less than 0% but less than 10%. The process b is associated with the progress amount that is not less than 10% but less than 30%.

The horizontal axis of FIG. 8 is time. In FIG. 8, the broken lines illustrate the imaging timing by the imager 20. The imager 20 starts imaging at a timing t1. The start time of the imaging is treated as the start time of the process a. The progress amount is determined to be less than 10% until a timing t2. Therefore, it is determined that the process a is being performed from the timing t1 to t2. It is determined that the progress amount is not less than 10% but less than 30% from a timing t3 to t4. Therefore, it is determined that the process b is being performed from the timing t3 to t4. It is determined that the progress amount is not less than 30% at a timing t5. Therefore, it is determined that another process is being performed at the timing t5.

In the example of FIG. 8, the following two methods are applicable as the method for calculating the actual man-hours.

In a first method, the timing t1 to the timing t2 is calculated as the actual man-hours of the process a; and the timing t3 to the timing t4 is calculated as the actual man-hours of the process b.

In a second method, the timing t1 to the timing t3 is calculated as the actual man-hours of the process a; and the timing t3 to the timing t4 is calculated as the actual man-hours of the process b. Or, the timing t1 to the timing t2 is calculated as the actual man-hours of the process a; and the timing t2 to the timing t4 is calculated as the actual man-hours of the process b.

According to the first method, a difference occurs between the finish time of the process a and the start time of the process b. Therefore, the calculated actual man-hours are less than the actual man-hours. As in the second method, the difference between the calculated actual man-hours and the actual man-hours can be reduced for two continuous processes by matching the start time of the previous process and the finish time of the subsequent process.

FIG. 9 is a flowchart illustrating processing when training the classifier according to the embodiment.

First, the user uses the input part 21 to set the data necessary for determining the progress (step S1) and stores the data in the memory 15. For example, the range of each color, the position of the article in the image, etc., are set. Also, the user stores the task plan, the classifier to be trained, the identifier, etc., in the memory 15 as appropriate. The user prepares the teaching data (step S2) and stores the teaching data in the memory 15. The teaching data includes multiple sets of the training image and the progress amount. The first acquisition part 11 acquires the area data from each of the training images (step S3). The first acquisition part 11 trains the classifier by using the multiple sets of area data (step S4). As described above, the training may be performed by either supervised learning or unsupervised learning. The first acquisition part 11 stores the trained classifier in the memory 15.

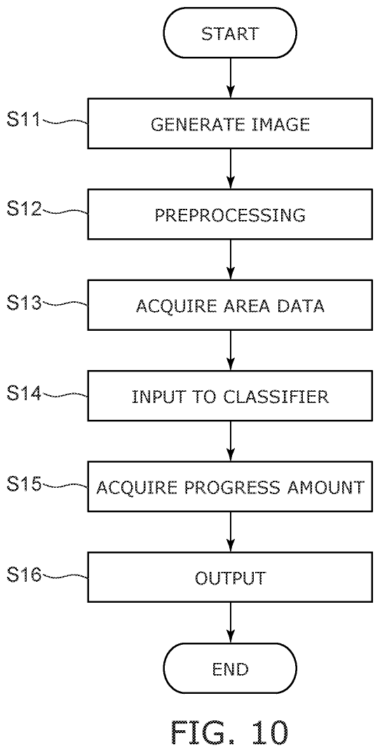

FIG. 10 is a flowchart illustrating processing of the progress determination system according to the embodiment.

The imager 20 images an article relating to the task and generates an image (step S11). The first acquisition part 11 performs preprocessing of the image (step S12). The first acquisition part 11 acquires area data from the image (step S13). The second acquisition part 12 inputs the area data to the classifier (step S14) and obtains a classification result. The second acquisition part 12 acquires the progress amount corresponding to the classification result (step S15). The second acquisition part 12 outputs a determination result of the progress amount (step 516).

Advantages according to the embodiment will now be described.

In the progress determination system 1 according to the embodiment, the area data is used to determine the progress. The area of the color in the image is not easily affected by the state (the orientation, the position, the structures of details, etc.) of the article. For example, the change of the area value of the color is not easily affected even when the state of the article in the task has changed from the pre-assumed state of the article. By using the area data, the effects of the state of the article on the determination result of the progress amount can be reduced, and the determination accuracy of the progress amount can be increased.

As long as there is a correlation between the progress of the task and the area value of the color in the image, the progress determination system 1 is applicable to a wide range of tasks such as manufacturing, logistics, construction, inspection, etc.

### FIRST MODIFICATION

In addition to the area data, edge data may be used to determine the progress amount. The first acquisition part 11 performs edge detection in the image as well as acquiring the area data from the image of the article. A Canny edge technique or a Sobel technique can be used for the edge detection. The threshold for the luminance change in the edge detection is preset by the user and stored in the memory 15. Multiple edges are extracted from the image by the edge detection; and edge data is acquired. The first acquisition part 11 outputs the edge data to the second acquisition part 12 and stores the edge data in the memory 15.

The first acquisition part 11 also acquires the edge data and the area data from the training image when training the classifier. The first acquisition part 11 acquires a set of the area data and the edge data from each of the multiple training images and trains the classifier. In supervised learning, the classifier is trained to output a classification result that indicates the progress amount according to the input of the sets of the area data and the edge data.

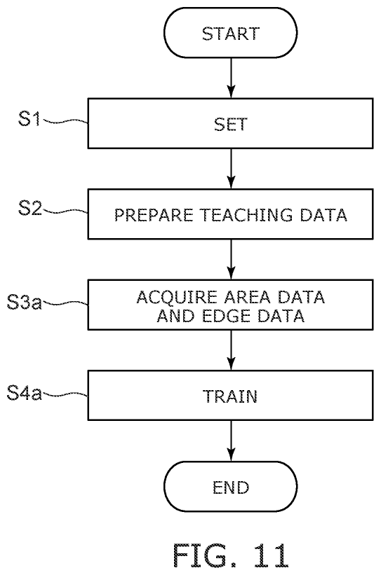

FIG. 11 is a flowchart illustrating the processing when training the classifier in the first modification of the embodiment.

Similarly to the flowchart illustrated in FIG. 9, the user sets the data necessary for the determination of the progress amount (step S1). At this time, the user sets a threshold for the edge detection in addition to the range of each color. The user prepares the teaching data (step S2). The first acquisition part 11 acquires the area data and the edge data from each of the training images (step S3a). The first acquisition part 11 trains the classifier by using the area data and the edge data (step S4a).

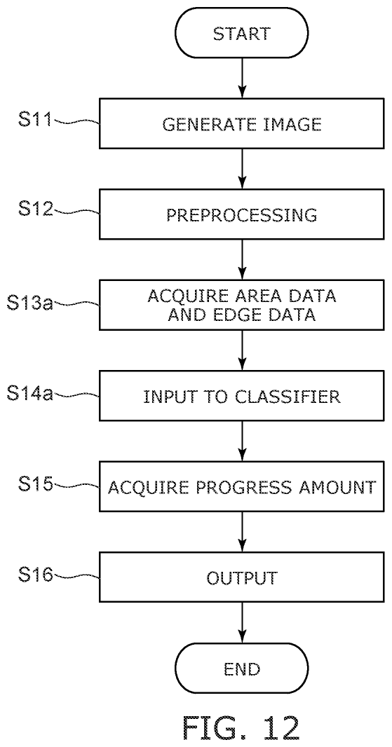

FIG. 12 is a flowchart illustrating processing of the progress determination system according to the first modification of the embodiment.

Steps S11 and S12 are executed similarly to the flowchart illustrated in FIG. 10. The first acquisition part 11 acquires the area data and the edge data from the image (step S13a). The second acquisition part 12 inputs the area data and the edge data to the classifier (step S14a) and obtains the classification result. The second acquisition part 12 acquires the progress amount corresponding to the classification result (step S15). The second acquisition part 12 outputs the determination result of the progress amount (step S16).

By using the edge data in addition to the area data, the determination accuracy of the progress amount can be further increased when there is a correlation between the progress amount of the task and the configuration of the article.

### SECOND MODIFICATION

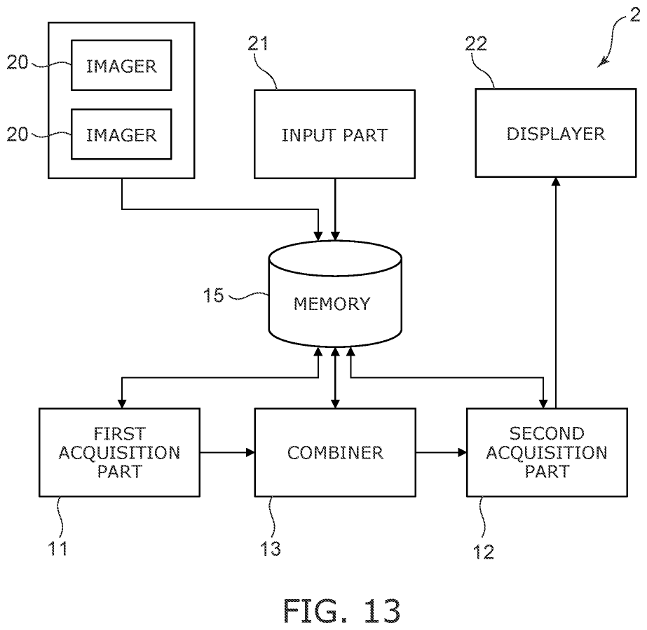

FIG. 13 is a schematic view illustrating a progress determination system according to a second modification of the embodiment.

The progress determination system 2 according to the second modification further includes a combiner 13. The progress determination system 2 includes multiple imagers 20.

The imagers 20 generate multiple images by imaging the same article at the same timing from mutually-different positions and angles. The imagers 20 repeatedly image the article and store the images in the memory 15. Article identification data of the imaged article, task identification data of the task to which the article is related, and the imaging time are associated with each other in the image.

A deviation may exist between the imaging timing of the imagers 20 within a range in which a substantial difference of the progress amount does not occur. For example, in the determination of the progress amount of a task that takes one day, a deviation of less than 1 minute between the imaging timing of the imagers 20 may exist. In such a case as well, the imagers 20 can be considered to be imaging the article at substantially the same timing.

The first acquisition part 11 acquires the area data from each of the images, associates the area data with the article identification data, the task identification data, and the imaging time of the image that is the basis, and stores the result in the memory 15. The first acquisition part 11 transmits the area data, the article identification data, the task identification data, and the imaging time to the combiner 13.

The combiner 13 selects multiple sets of area data based on multiple images that are imaged at the same timing. The combiner 13 combines the selected multiple sets of area data into one set of area data. For example, the combiner 13 averages the area values of the colors of the multiple sets of area data. Or, the combiner 13 may combine the multiple sets of area data based on the certainties of the multiple sets of area data.

At least one selected from the following first to fourth certainties can be used as the certainty.

The first certainty corresponds to the reliability of each set of the area data and is preset by the user. As the accuracy of the area data calculated from the image increases, the reliability of the area data increases, and the first certainty is set to be larger.

The second certainty is the size of the article in the image. When a portion of the image is cut out by the preprocessing, the size of the cut-out image corresponds to the size of the article. The combiner 13 sets the second certainty based on the size of the cut-out image. Or, the size of the article in the image is dependent on the distance between the article and the imager 20. A value that corresponds to the distance between the article and the imager 20 may be preset by the user as the second certainty.

The third certainty is the angle of the imager 20 with respect to the article. For example, when a region in which the color of the article changes according to the progress of the task is oriented upward, the change of the color has a high likelihood of appearing more accurately in an image of the article that is imaged from above. A value that corresponds to the angle of the imager 20 with respect to the article is preset by the user as the third certainty.

The fourth certainty is based on the size of the region in which the human is visible in the image. The area value is not accurately calculated if a portion of the article is hidden by a human in the image. For example, the first acquisition part 11 cuts out a portion of the image. The first acquisition part 11 identifies the human in the cut-out image and removes the region in which the human is visible. The combiner 13 reduces the fourth certainty as the size of the removed region increases. Or, the combiner 13 may reduce the fourth certainty as the proportion of the size of the removed region to the size of the cut-out image increases.

The combiner 13 calculates the certainty for each set of the area data. When two or more of the four certainties are used, one certainty is calculated by summing the certainties. One certainty may be calculated by using a weighted sum by using weights set for each of the two or more certainties.

The combiner 13 uses the multiple certainties to combine the multiple sets of area data into one set of area data. For example, the combiner 13 normalizes the multiple certainties so that the sum of the multiple certainties is “1”. The combiner 13 sums the multiple sets of area data and the normalized multiple certainties and sums the cumulative sums. One combined set of area data is obtained thereby.

The second acquisition part 12 inputs the combined area data to the classifier and acquires the classification result.

Processing of the progress determination system 2 will now be described with reference to specific examples.

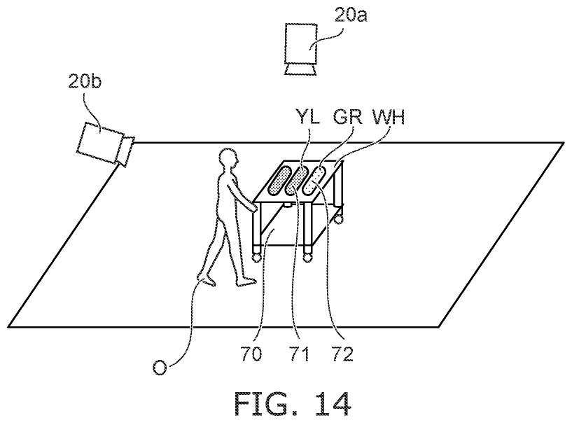

FIG. 14 is a schematic view illustrating a work site to which the progress determination system according to the second modification of the embodiment is applied.

Imagers 20a and 20b are mounted in the work site illustrated in FIG. 14. The imagers 20a and 20b image a wagon 70 from mutually-different positions and angles. Components 71 and 72 are located on the top surface of the wagon 70. A worker O sequentially picks the components 71 and 72 from the wagon 70 and assembles the components 71 and 72 in a device located in another location. For example, the color of the top surface of the wagon 70 is white (WH). The color of the component 71 is yellow (YL). The color of the component 72 is green (GR).

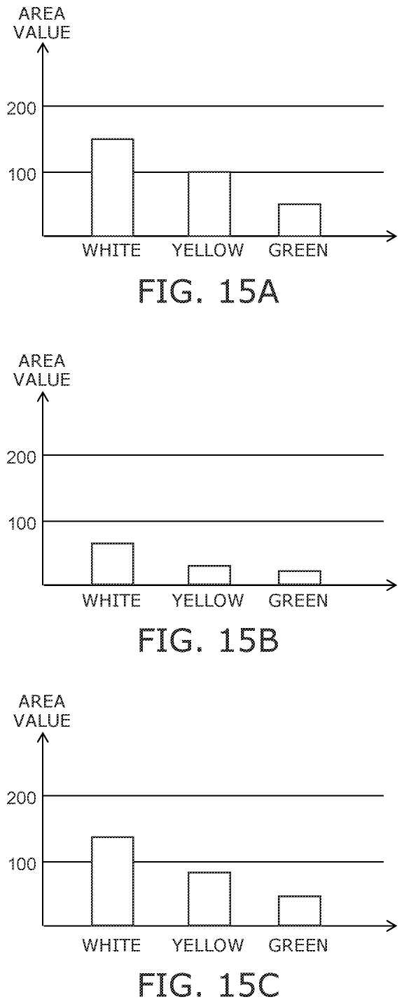

FIGS. 15A to 15C are graphs illustrating examples of area data.

The imagers 20a and 20b image the top surface of the wagon 70, the component 71, and the component 72 at the same timing. A first image and a second image are generated respectively by the imagers 20a and 20b. The first acquisition part 11 acquires first area data from the first image and acquires second area data from the second image. FIGS. 15A and 15B respectively illustrate the first and second area data. The combiner 13 combines the first and second area data. The combiner 13 refers to the first to fourth certainties.

For example, for the first certainty, the reliability of the first area data and the reliability of the second area data are equivalent. The user sets the same value for the first certainty of the first area data and the first certainty of the second area data.

For the second certainty, the distance between the wagon 70 and the imager 20a is less than the distance between the wagon 70 and the imager 20b. The user sets the second certainty of the first area data to be greater than the second certainty of the second area data.

For the third certainty, the imager 20a is located directly above the wagon 70 and squarely faces the top surface of the wagon 70. The imager 20b images the wagon 70 from obliquely upward. Compared to the imager 20b, the imager 20a easily images the entire wagon 70, the component 71, and the component 72. The user sets the third certainty of the first area data to be greater than the third certainty of the second area data.

For the fourth certainty, for example, the worker O is not visible in the first image. The worker O is visible in the second image. In such a case, the first acquisition part 11 removes the region in which the worker O is visible from the second image in the preprocessing. The combiner 13 reduces the fourth certainty of the second area data according to the proportion of the size of the removed region to the size of the second image.

The combiner 13 calculates one certainty for the first area data by summing the first to fourth certainties. The combiner 13 calculates one certainty for the second area data by summing the first to fourth certainties. The combiner 13 normalizes the certainties so that the sum of the certainty of the first area data and the certainty of the second area data is “1”. The combiner 13 multiplies the normalized certainties by the area values of the first area data. The combiner 13 multiplies the normalized certainties by the area values of the second area data. The combiner 13 adds the cumulative sum of the first area data and the certainty and the cumulative sum of the second area data and the certainty for each color. Thereby, the multiple sets of area data are combined into one.

FIG. 15C is an example of the result of combining the first and second area data illustrated in FIGS. 15A and 15B. In the example, the certainty of the first area data is greater than the certainty of the second area data. Therefore, the difference between the first area data and the combined area data is less than the difference between the second area data and the combined area data. The second acquisition part 12 inputs the area data illustrated in FIG. 15C to the classifier and acquires the classification result.

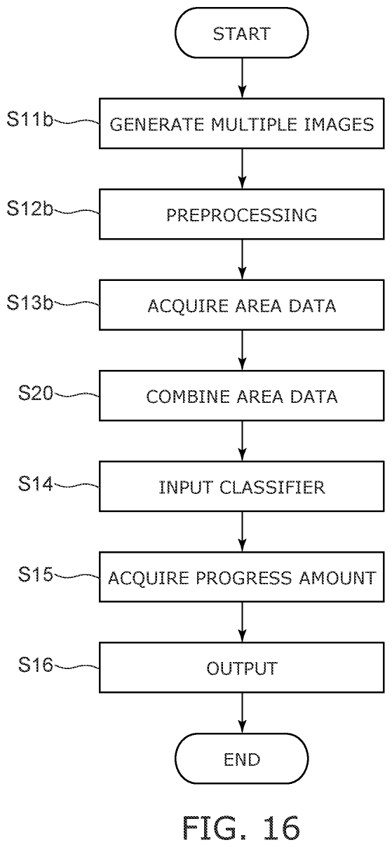

FIG. 16 is a flowchart illustrating the processing of the progress determination system according to the second modification of the embodiment.

The multiple imagers 20 generate multiple images by imaging the article at the same timing (step S11b). The first acquisition part 11 performs preprocessing on the images (step S12b). The first acquisition part 11 acquires area data from each of the images (step S13b). The second acquisition part 12 combines the multiple sets of area data into one (step S20). Thereafter, steps S14 to S16 are executed similarly to the flowchart illustrated in FIG. 10.

Similarly to the first modification, edge data may be used in the second modification. The first acquisition part 11 acquires the area data and the edge data from images that are imaged at the same timing. The combiner 13 combines the multiple sets of area data into one set of area data. The combiner 13 combines the multiple sets of edge data into one set of edge data. For example, the first acquisition part 11 generates one combined set of edge data by superimposing the multiple sets of edge data. Or, the first acquisition part 11 may generate one combined set of edge data by synthesizing the multiple sets of edge data by using Poisson image editing. The second acquisition part 12 inputs the area data and the edge data to the classifier and acquires the classification result.

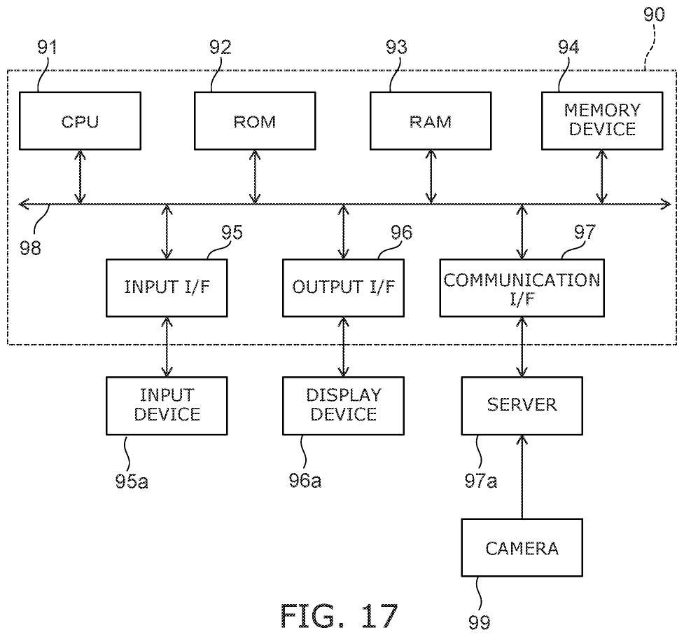

FIG. 17 is a schematic view illustrating a hardware configuration.

The progress determination system 1 according to the embodiment can be realized by the hardware configuration illustrated in FIG. 17. A processing device 90 illustrated in FIG. 17 includes a CPU 91, ROM 92, RAM 93, a memory device 94, an input interface 95, an output interface 96, and a communication interface 97.

The ROM 92 stores programs that control the operations of a computer. A program that is necessary for causing the computer to realize the processing described above is stored in the ROM 92. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the memory device 94. When executing the program, the CPU 91 executes various processing by controlling configurations via a system bus 98.

The memory device 94 stores data necessary for executing the programs and data obtained by executing the programs.

The input interface (I/F) 95 connects the processing device 90 and an input device 95a. An input I/F 95 is, for example, a serial bus interface such as USB, etc. The CPU 91 can read various data from the input device 95a via the input I/F 95.

The output interface (I/F) 96 connects the processing device 90 and a display device 96a. The output I/F 96 is, for example, an image output interface such as Digital Visual Interface (DVI), High-Definition Multimedia Interface (HDMI (registered trademark)), etc. The CPU 91 can transmit the data to the display device 96a via the output I/F 96 and can cause the display device 96a to display the image.

The communication interface (I/F) 97 connects the processing device 90 and a server 97a that is outside the processing device 90. The communication I/F 97 is, for example, a network card such as a LAN card, etc. The CPU 91 can read various data from the server 97a via the communication I/F 97. A camera 99 images the article and stores the image in the server 97a.

The memory device 94 includes not less than one selected from a hard disk drive (HDD) and a solid state drive (SSD). The input device 95a includes not less than one selected from a mouse, a keyboard, a microphone (audio input), and a touchpad. The display device 96a includes not less than one selected from a monitor and a projector. A device such as a touch panel that functions as both the input device 95a and the display device 96a may be used.

The processing device 90 functions as the first acquisition part 11, the second acquisition part 12, and the combiner 13. The memory device 94 and the server 97a function as the memory 15. The input device 95a functions as the input part 21. The display device 96a functions as the displayer 22. The camera 99 functions as the imager 20.

By using the progress determination system or the progress determination method described above, the determination accuracy of the progress amount can be increased. Similar effects can be obtained by using a program to cause a computer to operate as the progress determination system.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD±R, DVD±RW, etc.), semiconductor memory, or a recording medium (non-transitory computer-readable storage medium) that can be read by another nontemporary computer.

For example, information that is recorded in the recording medium can be read by a computer (or an embedded system). The recording format (the storage format) of the recording medium is arbitrary. For example, the computer reads the program from the recording medium and causes the CPU to execute the instructions recited in the program based on the program. In the computer, the acquisition (or the reading) of the program may be performed via a network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. The above embodiments can be practiced in combination with each other.

What is claimed is:

1. A progress determination system, comprising:
a first acquisition part acquiring area data from an image of an article, the area data relating to area values of a plurality of colors, the article relating to a task; and
a second acquisition part acquiring a classification result from a classifier by inputting the area data to the classifier,
the classification result indicating a progress amount.

2. The system according to claim 1, wherein the area data includes one or more selected from the area values, a ratio between the area values, and distribution of the area values.

3. The system according to claim 2, wherein
the first acquisition part calculates a plurality of numbers of pixels of the plurality of colors as the area values by determining colors of pixels included in the image based on ranges of the plurality of pixel values, and
the plurality of pixel values corresponds respectively to the plurality of colors.

4. The system according to claim 1, wherein
the first acquisition part further acquires edge data of an edge of the article from the image, and
the second acquisition part acquires the classification result by inputting the area data and the edge data to the classifier.

5. The system according to claim 1, further comprising:
a combiner,
the first acquisition part acquiring a plurality of sets of the area data from a plurality of the images of the article,
the plurality of images being taken from mutually-different angles at a same timing,
the combiner combining the plurality of sets of area data into one set of area data based on certainties of the plurality of sets of area data,
the second acquisition part acquiring the classification result by inputting the combined area data to the classifier.

6. The system according to claim 5, wherein
the certainties of the plurality of sets of area data are based on not less than one selected from a first certainty, a second certainty, a third certainty, and a fourth certainty,
the first certainty is set to correspond to reliabilities of the sets of area data,
the second certainty is set to correspond to a size of the article in the images,
the third certainty is set to correspond to angles with respect to the article of imagers imaging the images, and
the fourth certainty is set to correspond to a size of a human in the images.

7. The system according to claim 1, further comprising:
an imager imaging the article,
the first acquisition part cutting out a region from an image and acquiring the area data from the cut-out image,
the image being imaged by the imager, the article being visible in the region.

8. The system according to claim 1, wherein
the first acquisition part acquires the area data after removing a region from the image, and
a human is visible in the region.

9. The system according to claim 1, further comprising:
a displayer displaying the progress amount, performance of the task, and a plan of the task,
the performance of the task being calculated based on a time of imaging the image,
the plan of the task being preset.

10. The system according to claim 1, wherein
the classifier is trained by using area data acquired from a training image as input data and by using a progress amount corresponding to the training image as a label,
the article is visible in the training image, and
the area data acquired from the image is input to the trained classifier.

11. A progress determination method, the method comprising:
acquiring area data of area values of a plurality of colors from an image of an article, the article relating to a task; and
acquiring a classification result from a classifier by inputting the area data to the classifier,
the classification result indicating a progress amount.

12. A storage medium storing a program,
the program causing a computer to:
acquire area data of area values of a plurality of colors from an image of an article, the article relating to a task; and
acquire a classification result from a classifier by inputting the area data to the classifier,
the classification result indicating a progress amount.
